(19) United States
(12) Patent Application Publication
(10) Pub. No.: US 2016/0052363 A1
(43) Pub. Date: Feb. 25, 2016

(54) Method for Controlling a Ventilation/Air-Conditioning System of a Vehicle, and Vehicle Having Such a Ventilation/Air-Conditioning System

(71) Applicant: Bayerische Motoren Werke Aktiengesellschaft, Muenchen (DE)

(72) Inventors: Ralph OSTERMEIER, Wolfersdorf (DE); Gerald RUEHL, Muenchen (DE)

(21) Appl. No.: 14/931,924

(22) Filed: Nov. 4, 2015

Related U.S. Application Data
(63) Continuation of application No. PCT/EP2014/063320, filed on Jun. 25, 2014.

(30) Foreign Application Priority Data
Jul. 19, 2013 (DE) 10 2013 214 071.1

(51) Int. Cl. B60H 1/00

(52) U.S. Cl. CPC B60H 1/00821; B60H 1/00985; B60H 1/00035; B60H 2001/0015

(57) ABSTRACT

A method for controlling a ventilation/air-conditioning system of a vehicle and a vehicle having such a system, are provided. In a recirculated-air mode in which air in the passenger compartment is circulated and a fresh-air supply is shut off, at least one quality parameter of the recirculated air is measured at a point in the air duct system at which fresh air mixes with recirculated air to form mixed air. When the fresh-air supply is briefly opened fresh air from the environment briefly enters the air duct system, mixes with recirculated air, and at least one quality parameter of the mixed air is measured and compared with that of the recirculated air. The recirculated-air mode is maintained if the at least one quality parameter of the mixed air is worse than that of the recirculated air, and a switch to fresh air mode is made if the at least one quality parameter of the mixed air is better than that of the recirculated air.

### CROSS REFERENCE TO RELATED APPLICATIONS

This application is a continuation of PCT International Application No. PCT/EP2014/063320, filed Jun. 25, 2014, which claims priority under 35 U.S.C. §119 from German Patent Application No. 10 2013 214 071.1, filed Jul. 19, 2013, the entire disclosures of which are herein expressly incorporated by reference.

### BACKGROUND AND SUMMARY OF THE INVENTION

The present invention relates to a method of controlling a ventilation/air-conditioning system of a motor vehicle, as well as to a vehicle having such a ventilation/air-conditioning system.

Some vehicle air-conditioning systems have a so-called “AUC-Sensor” (Air Quality Sensor) which, viewed from the vehicle occupant compartment, is arranged forward of the front wall in the water separation area. Because of the arrangement of the AUC sensor in the intake area for fresh air, the sensor can measure only the quality of the fresh air. No air flows around the sensor in the recirculated-air mode. No measuring of the quality of the recirculated air circulating in the vehicle occupant compartment is therefore possible in the recirculated-air mode.

From German Patent Document DE 4105724 A1, an air-conditioning system having two sensors is known, which sensors are each provided for detecting the concentration of the pollutants contained in the air. One of the two sensors is arranged forward of the front wall and is provided for determining the air quality of the ambient air (fresh air). The other of the two sensors is arranged behind the front wall, i.e., in the area of the vehicle occupant compartment, and is provided for determining the quality of the vehicle occupant compartment air. An arrangement of this type having two sensors requires relatively high expenditures.

It is an object of the invention to create a method of controlling a ventilation/air-conditioning system of a vehicle by which the quality of the air is taken into account in all operating modes in a constructively simple manner. It is another object of the invention to create a vehicle that is equipped with a corresponding ventilation/air-conditioning system.

The starting point of the invention is a method of controlling a ventilation/air-conditioning system of a vehicle, whereby, in a so-called recirculated-air mode, the air present in the vehicle occupant compartment is circulated in the vehicle occupant compartment and in at least one part of an air duct system of the ventilation/air conditioning system, in which case the fresh-air supply from the environment into the vehicle occupant compartment is shut off.

According to the invention, at least one quality parameter of the recirculated air is measured by a sensor device, specifically at a point of the air duct system of the ventilation/air-conditioning system at which fresh air mixes with recirculated air to form mixed air when the fresh-air supply is open, i.e., in the fresh-air mode of the ventilation/air-conditioning system. As mentioned above, in the recirculated-air mode, the fresh-air supply is shut off, so that only recirculated air is situated at the point at which the sensor device is arranged in the air duct system. In other words, in the recirculated-air mode the sensor device is not in a flow connection with the environment. In the recirculated-air mode, the flow connection to the environment is shut off by a shut-off element (such as a shut-off flap).

Recirculated air is air that was taken from the vehicle occupant compartment or entered the air duct system of the ventilation/air-conditioning system from the vehicle occupant compartment. Fresh air is air that entered the air duct system of the ventilation/air-conditioning system from the environment. Mixed air is air that results from mixing fresh air and recirculated air.

In order to achieve optimal air quality in the vehicle occupant compartment, there should be no unnecessarily long driving in the recirculated-air mode. Inversely, a switching to the fresh-air mode should take place only when the quality of the ambient air is better than that of the recirculated air.

According to the invention, it is provided to (regularly) briefly open the fresh-air supply while operating in the recirculated-air mode, which has the result that the air-duct system of the ventilation/air-conditioning system, at least in the area of the sensor device, is briefly “flushed” with fresh air from the environment. Recirculated air present in the area of the sensor device will therefore mix during the flushing phase with the fresh air entering from the environment to form mixed air.

Subsequently at least one quality parameter of the mixed air will be measured by the sensor device and compared with the at least one previously measured quality parameter of the recirculated air.

According to the invention, the recirculated air mode is maintained when the at least one quality parameter of the mixed air is worse than the at least one quality parameter of the recirculated air, or a switch-over to the fresh-air mode takes place when the at least one quality parameter of the mixed air is better than that of the recirculated air, which implies that the fresh air admixed to the recirculated air is qualitatively better than the recirculated air.

It is a significant advantage of the invention that, in contrast to the above-mentioned German Patent Document DE 4105724 A1, an air-quality-dependent ventilation/air-conditioning control can be achieved by a single sensor device in the recirculated-air mode as well as in the mixed-air mode.

In all operating modes of the ventilation/air-conditioning system, an optimal control can thereby be achieved.

It is a further advantage of the invention that, by the method according to the invention, the efficiency of the air-conditioning system can be increased and a fogging-up of the windows in the vehicle occupant compartment as a result of excessive moisture can be avoided.

According to a further development of the invention, the quality of the fresh air and/or the quality of the recirculated air is displayed by way of a display device arranged in the vehicle occupant compartment. As an alternative, it may also only be displayed whether the quality of the fresh is currently better than that of the recirculated air present in the vehicle, or vice-versa.

The respective information can be displayed, for example, by way of a display (man-machine-interface) arranged in the center area of the instrument panel, and/or by way of an instrument cluster arranged forward of the steering wheel, and/or by way of an LED display arranged in the area of the instrument panel, and/or by way of a display device generating a virtual image (such as a so-called “head-up display” or the like).

A vehicle equipped with such a ventilation/air-conditioning system may, for example, be a conventional vehicle driven only by an internal-combustion engine, a hybrid vehicle or a vehicle driven only by an electric motor. The invention is by no means limited to passenger cars but can also be applied to commercial vehicles (such as trucks, tractors, fork lifts, etc.) and generally in the case of vehicles equipped with ventilation/air-conditioning systems.

The ventilation/air-conditioning system of such a vehicle has an air input, which can be shut off by a shut-off element, for taking in fresh air from the environment, a recirculated-air input, which can be shut off by a shut-off element, for taking in recirculated air from a vehicle occupant compartment, as well as an air output, by way of which air present in the air duct system of the ventilation/air-conditioning system can be introduced into the vehicle occupant compartment.

The above-mentioned sensor device is arranged in an area of the air duct system in which, when the fresh-air input is open and the recirculated input is simultaneously open, fresh air and recirculated air flow in and mix with one another. The sensor device is provided for measuring, depending on the operating mode of the ventilation/air-conditioning system (fresh-air mode, recirculated-air mode, mixed-air mode), at least one quality parameter of the recirculated air or fresh air present in the area of the sensor device or of the mixed air present there and containing recirculated air and fresh air.

The sensor device may be arranged in a housing of a so-called “air-conditioning unit” of the ventilation/air-conditioning system.

The sensor device is connected to an electronic analysis/control system which has an electronic memory, in which at least one quality parameter of the air measured in the recirculated air mode is stored. In addition, a logic is implemented in the electronic system which carries out a comparison between the at least one quality parameter measured in the recirculated-air mode and the at least one quality parameter measured in the fresh-air mode.

The at least one quality parameter of the air detected by the sensor device may, for example, be the concentration of the fine particulates contained in the air and/or the concentration of a gas constituent contained in the air, such as the concentration of the carbon dioxide contained in the air, of the NOₓ (particularly NO, NO₂) contained in the air, and/or the moisture of the air and/or the temperature of the air.

According to a further development of the invention, the sensor device has a sensor housing, in which at least two individual sensors can be arranged, each of the individual sensors being provided for measuring exactly one quality parameter of the air. The sensor device may therefore be a “multifunction sensor”, which can measure at least two quality parameters (for example, the fine particulate pollution and the temperature). However, only a single sensor (such as a fine-particulate sensor) may be provided.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a vehicle ventilation/air-conditioning system in accordance with an embodiment of the present invention.

### DETAILED DESCRIPTION

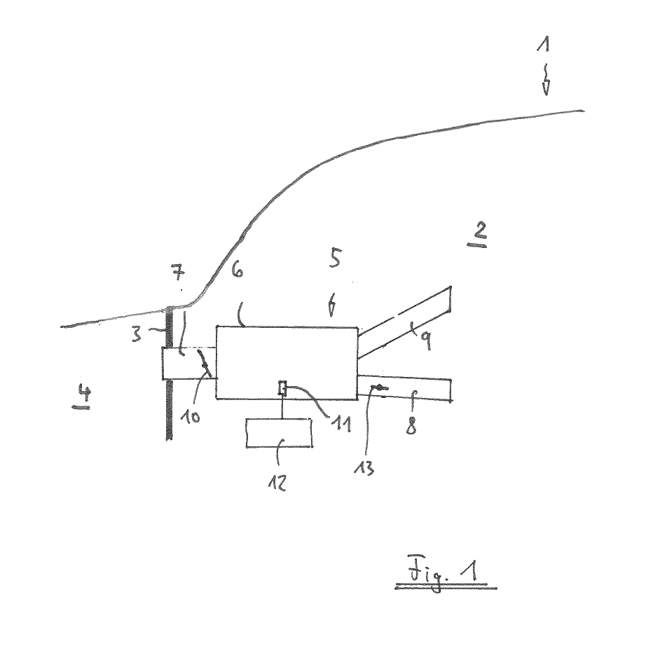

FIG. 1 illustrates a vehicle 1 having a vehicle occupant compartment 2 which is separated from an engine compartment 4 by a front wall 3. In the forward area of the vehicle occupant compartment 2, an air conditioning unit 5 is arranged (which is illustrated here in a significantly enlarged manner). The air conditioning unit 5 has a housing 6, which is part of an air duct system of an air-conditioning system of the vehicle.

The air-conditioning unit 5 has a fresh-air input 7 by way of which fresh air can be drawn in from the environment of the vehicle. The air-conditioning unit 5 further has a recirculated-air input 8 and an air output 9. By way of the recirculated-air input 8 recirculated air can flow from the vehicle occupant compartment 2 into the housing 6 of the air-conditioning unit 5. By way of the air output 9, air is blown into the vehicle occupant compartment 2 by way of air outlets not illustrated here.

In the recirculated-air mode, the fresh-air input 7 is shut off by way of a shut-off element 10, which is shown here by a shut-off flap. In the recirculated-air mode, the air-conditioning unit 5 draws in air from the vehicle occupant compartment 2 by way of the recirculated-air input 8 from the vehicle occupant compartment 2 and conditions (heats, cools and/or dehumidifies) the taken-in recirculated air and blows the conditioned recirculated air out again into the vehicle occupant compartment 2 by way of the air output 9.

At least one “quality parameter” of the air present in the housing 6 for the air-conditioning unit 5 is measured by sensor 11. The sensor 11 may particularly be a multifunction sensor, which can measure two, three or more parameters of the air (for example, the air temperature, the air humidity, the fine-particulate pollution, the CO2-content, the NOx-content, etc. The sensor 11 is electrically connected to an electronic analysis or control system 12.

A recirculated-air mode is indicated particularly when the ambient air is of worse quality than the air present in the vehicle occupant compartment 2.

The quality of the air can now be measured by the sensor device 11 at a very definite point in the air duct system of the ventilation/air-conditioning system. The sensor 11, which is arranged here inside the housing 6 of the air-conditioning unit 5—in general terms—is arranged at a point of the air duct system of the ventilation/air-conditioning system at which fresh air and recirculated air can mix when the fresh-air input 7 is open and the recirculated-air input 8 is simultaneously open.

The recirculated-air input 8 can also be shut off by a shut-off element 13 (such as a shut-off flap). However, in the recirculated-air mode illustrated in FIG. 1, the shut-off element 13 is open.

Viewed in the flow direction of the fresh-air input 7 and viewed in the flow direction of the recirculated-air input 8, the sensor 11 is therefore arranged behind the shut-off element 10 of the fresh-air input 7 and behind the shut-off element 13 of the recirculated-air input 8, i.e. at a point at which the fresh air and the recirculated air can mix or are already mixed.

When, as illustrated in FIG. 1, the vehicle air-conditioning system is in the recirculated-air mode, the sensor 11 will measure only the quality of the recirculated air present in the interior of the housing 6 of the air-conditioning unit 5. In order to determine whether the fresh air is still worse or, in the meantime, has become better again than the recirculated air present in the vehicle occupant compartment and taken in by way of the recirculated-air input 8, the air duct system of the air conditioning unit is flushed at least briefly with fresh air, either while the shut-off element 13 continues to be open also briefly opening the shut-off element 10, or while the shut-off element 13 is closed, opening the shut-off element 10.

This has the result that at least a certain amount of fresh air flows into the area in which the sensor 11 is situated. By way of the electronic analysis/control system 12, it is detected whether the quality of the resulting “mixed air” in the environment of the sensor 11 is thereby improved or impaired.

If the air quality is becoming worse, the shut-off element will immediately be closed again and the recirculated-air mode is continued. In contrast, if the air quality is improving, a switch-over takes place to the fresh-air mode in that shut-off element 10 is opened and shut-off element 13 of the recirculated-air input is closed.

In the fresh-air mode, the quality of the flowing-in fresh air can then be monitored by the sensor 11. The fresh-air mode is maintained if the air quality remains in an acceptable range. In contrast, if the quality of the fresh air falls below a predefined tolerance threshold (for example, fine-particulates or NOx pollution exceeds predefined values), a switch-over back to the recirculated-air mode takes place by closing the shut-off element 10 and by opening the shut-off element 13.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of controlling a ventilation/air-conditioning system of a vehicle having a controller and an air duct configured to receive air from a passenger compartment of the vehicle and to receive fresh air from outside of the passenger compartment, wherein the ventilation/air-conditioning system has a recirculated air mode in which the passenger compartment air is recirculated to the passenger compartment and the fresh air is shut off from the passenger compartment, and a fresh air mode in which the fresh air enters the air duct to mix with the recirculated air from the passenger compartment, comprising the acts of:
measuring in the air duct with an air quality sensor at least one quality parameter of the recirculated air when the ventilation/air-conditioning system is in the recirculated-air mode;
opening a fresh air supply configured to permit the fresh air to enter the air duct and mix with the recirculated air while the ventilation/air-conditioning system is in the recirculation mode;
measuring in the air duct with the air quality sensor the at least one quality parameter of the mixed fresh air and recirculated air;
comparing with the controller the at least one quality parameter of the recirculated air with the at least one quality parameter of the mixed fresh air and recirculated air;
controlling the operation of the ventilation/air-conditioning system with the controller based on the results of the comparison such that
the recirculated-air mode is maintained with the fresh air supply shut off if the comparison indicates that a quality of the recirculated air is better than a quality of the mixed fresh air and recirculated air, or
a switch-over to the fresh air mode is performed if the comparison indicates that the quality of the recirculated air is worse than the quality of the mixed fresh air and recirculated air.

2. The method according to claim 1, further comprising the act of:
displaying on a display arranged in the passenger compartment at least one of whether the recirculated air quality is better or worse than the fresh air quality and at least one of the recirculated air quality and the fresh air quality.

3. A vehicle having a ventilation/air-conditioning system for a passenger compartment of the vehicle, comprising:
an air duct having
a fresh air input configured to supply fresh air from outside the passenger compartment into the air duct,
a fresh air supply shut off configured to shut off the fresh air input,
a recirculated air input configured to receive recirculated air from the passenger compartment,
an air output configured to output air into the passenger compartment, and
an air quality sensor configured to sense at least one air quality parameter in the air duct; and
a controller configured to monitor the air quality sensor and control the operation of the fresh air supply shut off,
wherein when in a recirculated-air mode in which the passenger compartment recirculated air is recirculated through the air duct and the fresh air is shut off, the controller is configured to:
receive the at least one air quality parameter from the air quality sensor and determine a recirculated air quality,
open the fresh air supply shut off to permit the fresh air to enter the air duct and mix with the recirculated air while the ventilation/air-conditioning system is in the recirculation mode,
receive the at least one air quality parameter from the air quality sensor and determine an air quality of the mixed fresh air and recirculated air,
compare the recirculated air quality and the mixed air quality,
control the operation of the ventilation/air-conditioning system with the controller based on the results of the comparison such that
the recirculated-air mode is maintained with the fresh air supply shut off if the comparison indicates that the quality of the recirculated air is better than the quality of the mixed fresh air and recirculated air, or
a switch-over to a fresh air mode in which the fresh air enters the air duct to mix with the recirculated air is performed if the comparison indicates that the quality of the recirculated air is worse than the quality of the mixed fresh air and recirculated air.

4. The vehicle according to claim 3, wherein the air quality sensor is arranged in a housing of an air-conditioning unit of the ventilation/air-conditioning system.

5. The vehicle according to claim 3, wherein the controller includes a memory configured to store the at least one quality parameter of the recirculated air measured in the recirculated-air mode.

6. The vehicle according to claim 3, wherein the air quality sensor is configured to sense at least one of a concentration of fine particulates, a concentration of carbon dioxide, a concentration of the NOₓ, air humidity and air temperature.

7. The vehicle according to claim 6, wherein the air quality sensor has a housing in which at least two individual sensor elements are arranged, each of the at least two individual sensors being configured to sense one quality parameter.

8. The vehicle according to claim 3, wherein a display is arranged in the passenger compartment, the display being configured to display at least one of whether the recirculated air quality is better or worse than the mixed air quality and at least one of the recirculated air quality and the mixed air quality.

9. The vehicle according to claim 3, wherein
the air duct further comprises a recirculated air shut off configured to shut off the recirculated air entering the recirculated air input from the passenger compartment, and
the controller is configured such that the recirculated air shut off is shut off when the ventilation/air-conditioning system is in the fresh air mode.
